(19) United States
(12) Patent Application Publication
(10) Pub. No.: US 2008/0168932 A1
(43) Pub. Date: Jul. 17, 2008

(54) Thermocouple calibration in a furnace

(76) Inventors: Kai Tat Lim, Singapore (SG); Gerardo Abaring Pelaez, Singapore (SG)

Correspondence Address: CHRISTIE, PARKER & HALE, LLP, PO BOX 7068, PASADENA, CA, 91109-7068, US

(21) Appl. No.: 11/654,403

(22) Filed: Jan. 16, 2007

(51) Int. Cl. F23M 5/00; G01K 15/00

(52) U.S. Cl. 110/336; 374/1

(57) ABSTRACT

An assembly for thermocouple calibration in a furnace, a furnace and a method of performing thermocouple calibration in a furnace. The assembly comprises a base plate for a furnace process chamber, the base plate comprising a first through hole; a Boat Elevator (BE) cap for the furnace process chamber, the BE cap comprising a second through hole, wherein the base plate and the BE cap are configured such that the first and second through holes are aligned when the base plate and the BE cap are mounted to the furnace process chamber; and a plug structure having a plug element and a mounting plate; wherein the plug structure is configured such that the plug element is removably received in the aligned first and second through holes.

### FIELD OF INVENTION

The present invention relates broadly to an assembly for thermocouple calibration in a furnace, to a furnace and to a method of performing thermocouple calibration in a furnace.

### BACKGROUND

Thermocouple calibration in furnaces is an important aspect of maintenance in the semiconductor fabrication industry. Typically, the thermocouple calibration involves a number of separate tasks that need to be performed sequentially resulting in a significant time requirement. More particular, in thermocouple calibration for a typical furnace such as Atmospheric Pressure (AP) furnaces, an auto-profiling task is first conducted for calibration of an outer thermocouple with reference to an inner thermocouple incorporated in the furnace. Next, a flat-zone task is typically performed for calibration of the inner thermocouple with reference to an actual wafer temperature. Finally, a second auto-profiling task is performed for final calibration of the outer thermocouple with reference to the inner thermocouple.

During the above described typical thermocouple calibration processing, two different types of base plates are utilized, and must be alternated between the calibration tasks. More particular, a first quartz base plate without any opening or hole formed therein is used during the auto-profiling task, i.e. the same base plate as during the normal operation of the furnace.

For performing the flat-zone task, a quartz base plate with a through hole formed therein for entry of the flat-zone thermocouple has to be used instead of the first base plate, thus requiring exchange of the quartz base plates between those tasks. Finally, to perform the second auto-profiling task, the first base plate without the through hole formed therein needs to be replaced, to avoid leakage through the through hole which would adversely affect the calibration process.

As will be apparent from the above, the replacement of the different quartz base plates between the different tasks significantly increases the time investment required for the thermocouple calibration process. Significant time is required for allowing the quartz base plate to cool down after one task, before the base plate (together with other parts) may be dismantled from the furnace and replaced with the other base plate. Similarly, the same cooling down, dismantling, and reconfiguration, followed by ramping up of the furnace to the required temperatures will be encountered again between the flat-zone and the second auto-profiling tasks.

A need therefore exists to provide a method and system that seeks to address at least one of the above-mentioned disadvantages.

### SUMMARY

In accordance with a first aspect of the present invention there is provided an assembly for thermocouple calibration in a furnace, the assembly comprising a base plate for a furnace process chamber, the base plate comprising a first through hole; a Boat Elevator (BE) cap for the furnace process chamber, the BE cap comprising a second through hole, wherein the base plate and the BE cap are configured such that the first and second through holes are aligned when the base plate and the BE cap are mounted to the furnace process chamber; and a plug structure having a plug element and a mounting plate; wherein the plug structure is configured such that the plug element is removably received in the aligned first and second through holes.

The base plate may be formed from quartz.

The plug element may be formed from quartz.

The plug structure may further comprise an O-ring for disposal between the mounting plate and the BE cap and around the second through hole for sealing the furnace process chamber.

The plug structure may further comprise a threaded mounting rod connected to the mounting plate for facilitating movement of the plug structure relative to the first and second through holes.

In accordance with a second aspect of the present invention there is provided a method of performing thermocouple calibration in a furnace, the method comprising the steps of providing a base plate for a furnace process chamber, the base plate comprising a first through hole; providing a BE cap for the furnace process chamber, the BE cap comprising a second through hole, wherein the base plate and the BE cap are configured such that the first and second through holes are aligned when the base plate and the BE cap are mounted to the furnace process chamber; and providing a plug structure having a plug element and a mounting plate; installing the plug structure such that the plug element is received in the aligned first and second through holes for an auto-profiling task; and removing the plug structure for a flat-zone task.

The method may further comprise re-disposing the plug structure such that the plug element is received in the aligned first and second through holes after the flatzone task for a further autoprofiling task.

The base plate may be formed from quartz.

The plug-element may be formed from quartz.

The method may further comprise disposing an O-ring between the mounting plate and the BE cap and around the second through hole for sealing the furnace process chamber for the auto-profiling tasks.

In accordance with a third aspect of the present invention there is provided a furnace comprising a process chamber; a base plate for the process chamber, the base plate comprising a first through hole; a BE cap for the process chamber, the BE cap comprising a second through hole, wherein the base plate and the BE cap are configured such that the first and second through holes are aligned when the base plate and the BE cap are mounted to the furnace process chamber; and a plug structure having a plug element and a mounting plate; wherein the plug structure is removably mounted to the BE cap such that the plug element is removably received in the aligned first and second through holes.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic cross-sectional diagram illustrating an assembly and method according to an example embodiment in an auto-profiling task configuration.

FIG. 2 shows a schematic cross-sectional diagram illustrating the assembly of FIG. 1 in a flat-zone task configuration.

FIG. 3 shows a photograph of an auxiliary structure of an assembly in accordance with one embodiment.

FIG. 4 shows a photograph of the auxiliary device of FIG. 3 mounted onto a furnace structure.

FIG. 5 shows a flowchart illustrating a method of performing a thermocouple calibration in a furnace according to an example embodiment.

### DETAILED DESCRIPTION

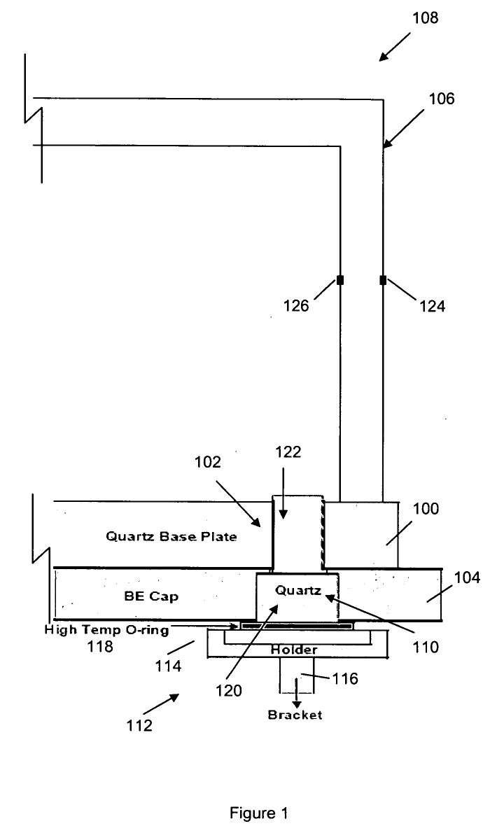

FIG. 1 shows a schematic cross-sectional diagram illustrating a device and method according to an example embodiment. In FIG. 1, a quartz base plate 100 having formed therein a through hole 102 is shown assembled between a Boat Elevator (BE) cap 104 and a process chamber or tube 106 of a furnace structure 108. The BE cap 104 also comprises a through hole 110, which is aligned with the through hole 102 formed in the base plate 100, in the assembled furnace structure 108. An auxiliary device structure 112 is provided in the example embodiment. The structure 112 comprises a holder plate 114 connected to a support beam 116. A bracket mechanism (not shown) is provided in the example embodiment to facilitate mounting of the structure 112 to the BE cap 104. A high temperature O-ring 118 is provided between a quartz block element 120 mounted on the holder plate 114 and the BE cap 104, such that a seal is formed around the through hole 110 in the BE cap 104. In the described example, the O-ring material high temperature Kalrez.

The quartz block element 120 is a single, machined part comprising three portions 121, 122, and 123 of different diameters. More particular, the base portion 121 has the largest diameter, and is received and mounted on the holder plate 114 using an “insert and turn” fastening mechanism in the example embodiment. The middle portion 121 has an intermediate diameter which is slightly smaller than the diameter of the through hole 110 in the BE cap 104, for receiving of the middle portion 122 inside the through hole 110. Lastly, the top portion 123 has the smallest diameter, which is slightly smaller than the through hole 102 in the quartz base plate 100 for receiving the top portion 122 inside the through hole 102.

In the configuration as shown in FIG. 1, a first auto-profiling task can be performed on the furnace structure 108 to calibrate an outer thermocouple 124 with reference to an inner thermocouple 126 of the furnace structure 108. During the first auto-profiling task, leakage through the through hole 102, 110 formed in quartz base plate 100 and the BE cap 104 respectively is avoided through use of the auxiliary structure 112 mounted onto the BE cap 104. In the example embodiment, quartz is chosen as the material for the block element 120 so that the auxiliary structure 112 can withstand the high temperature (typically up to 1100° C.) required.

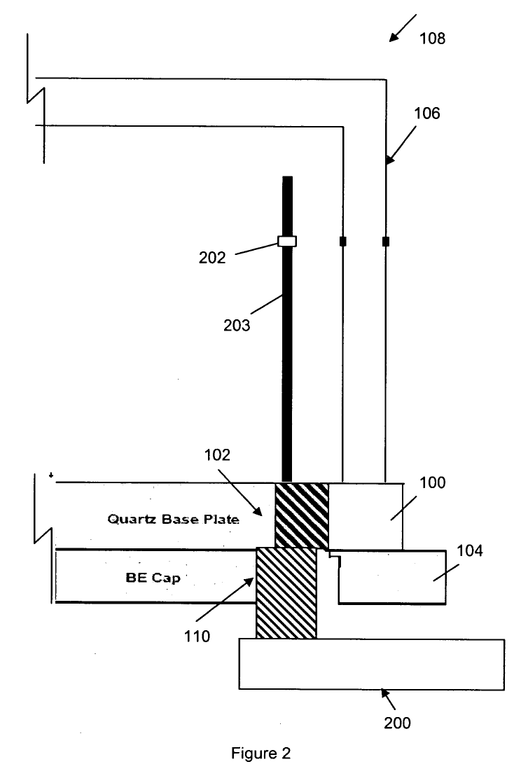

Turning now to FIG. 2, a schematic cross-sectional diagram illustrating the furnace structure 108 in a configuration for a flat-zone task is shown. In that configuration, the auxiliary structure 112 (compare FIG. 1) has been removed. In its place, a flat-zone jig 200 is used to mount and support a flat-zone thermocouple 202 located on a support rod 203 inside the process tube 106, and through the through openings 102, 110 in the quartz base plate 100 and the BE cap 104 respectively.

The example embodiment therefore advantageously enables a transition from the auto-profiling task to the flat-zone task without the need for exchanging the quartz base plate 100. In contrast, in existing techniques, a replacement of the quartz base plate is required to change from a quartz base plate without a through hole, for avoiding leakage, during the auto-profiling task, to a quartz base plate having a through hole formed therein, for insertion of thermocouple. As a result, the described method and system provides a fast and easy transition from the first auto-profiling task to the flat-zone task, in which replacement of the quartz base plate, and associated required cooling down, disassembly, re-assembly, and ramp up can advantageously be avoided.

Once the flat-zone task is completed in the configuration as shown in FIG. 2, the furnace structure 108 can be brought back into a configuration for the second auto-profiling task by removal of the flat-zone thermocouple 202 and the associated flat-zone jig 200, and re-insertion of the auxiliary structure 112, as shown in FIG. 1. Therefore, similarly, the described embodiment can provide a fast and easy transition from the flat-zone task to the second auto-profiling task, in which time wasted associated with the cooling down, disassembly, re-assembly, and ramping up of the furnace structure 108 are advantageously avoided.

Table 1 shows a comparison of thermocouple calibration processing performed on an AP furnace using an existing technique and using the technique of the described embodiment. From Table 1 it can be seen that a significant time reduction of at least 17 hours was achieved in that comparison.

TABLE 1

| BEFORE | | AFTER | |
|---|---|---|---|
| AUTOPROFILE | TIME (Hr) | AUTOPROFILE | TIME (Hr) |
| 1. Loading/Charging/ | 1 | 1. Loading/Charging/ | 1 |
| Boat Load | | Boat Load/Hole Plug | |
| 2. Ramp up | 1 | 2. Ramp Up | 1 |
| 3. Autoprofile | 6 | 3. Autoprofile | 6 |
| 4. Rampdown | 2 | Eliminated | 0 |
| 5. Boat Unload/Cooling/ | 1.5 | Eliminated¹⁾ | 0 |
| Dicharging/Unloading | | | |
| FLATZONE | | FLATZONE | |
| 6. Quartz Cooling/Boat | 3 | Eliminated | 0 |
| Teaching/Loading/ | | | |
| Charging/Boat Load | | | |
| 7. Ramp up/Stabilize | 3 | Eliminated | 0 |
| 8. Flatzone | 12 | 4. Flatzone | 12 |
| 9. Rampdown | 2 | Eliminated | 0 |
| 10. Boat unload/Cooling/ | 1.5 | Eliminated | 0 |
| Dicharging/Unloading | | | |
| AUTOPROFILE | | AUTOPROFILE | |
| 11. Quartz Cooling/Boat | 3 | Eliminated¹⁾ | 0 |
| Teaching/Loading/ | | | |
| Charging/Boat Load | | | |
| 12. Ramp up | 1 | Eliminated | 0 |
| 13. Autoprofile | 6 | 5. Autoprofile | 6 |
| 14. Rampdown | 2 | 6. Rampdown | 2 |
| 15. Boat Unload/Cooling/ | 1 | 7. Boat Unload/Cooling/ | 1 |
| Dicharging/Unloading | | Dicharging/Unloading | |
| TOTAL TIME | 46 | | 29 |

¹⁾The process for installing and removing the auxiliary structure typically will take no more than about ten minutes.

The described embodiment has the additional advantage of requiring very little, if any, specific training of maintenance personnel in conducting the thermocouple calibration tasks. As will be appreciated by a person skilled in the art, the required assembly/reassembly tasks involve simple mounting operations for securing the auxiliary structure by way of a bracket to the furnace structure, and similarly for mounting the flat-zone jig to the furnace structure.

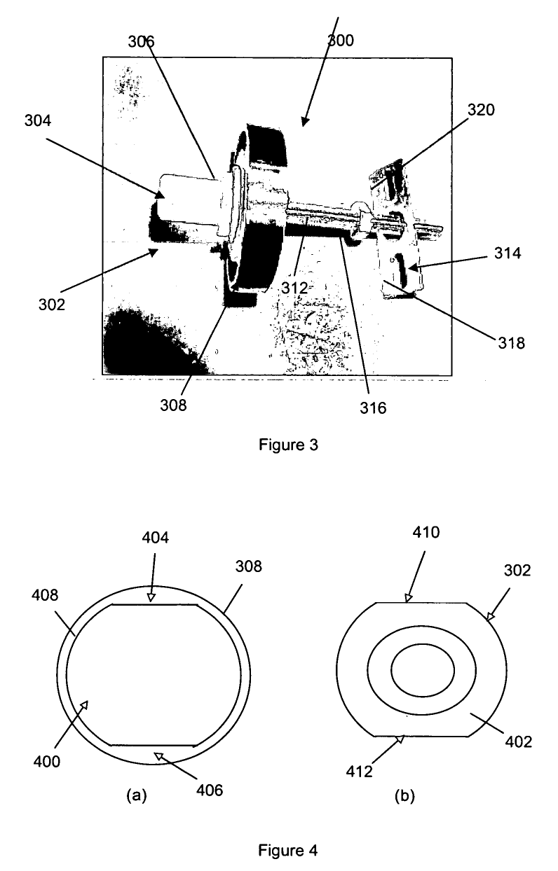

FIG. 3 shows a photograph of an auxiliary structure 300 in accordance with one embodiment. The auxiliary structure 300 comprises a quartz block element 302 supported on a stainless steel cap or plate 308, which is in turn attached to a mounting rod in the form of a threaded rod 312. A mounting bracket 314 slides onto the rod 312 and can be fixed in place utilising a nut 316. The mounting bracket 314 further comprises slits 318, 320 for securing the auxiliary device 300 to BE cap of a furnace structure.

When the auxiliary device 300 is mounted onto a BE cap of a furnace structure 401, the bracket rests on corresponding support brackets fixed onto a mounting tool for the BE cap. As will be appreciated by a person skilled in the art, the auxiliary device 300 is positioned with the bracket 314 mounted on corresponding pins formed on the support brackets being received in the slits 318, 320. The plate 308 is then moved towards the BE cap by pushing the threaded rod 312 upward, and the auxiliary device 300 is secured in place by tightening nut 316 against the bracket 314.

FIGS. 4a and b show schematic top views of plate 308 and the quartz block element 302 respectively. A recess 400 is formed in the plate 308 for receiving the base portion 402 of the quartz block element 302. Overhang portions 404, 406 are formed on the rim 408 of the plate 308, corresponding to the flattened portions 410, 412 of the perimeter of the base portion 402 of the quartz block element 302. As will be appreciated by a person skilled in the art, the quartz block element 302 can thus be secured to the plate 308 by inserting the base element 402 into the recess 400, and subsequently turning the quartz block element 302 such that the flattened portions 410, 412 are no longer aligned with the over hangs 406, 408, thus “locking” the quartz block element 302 onto the plate 308.

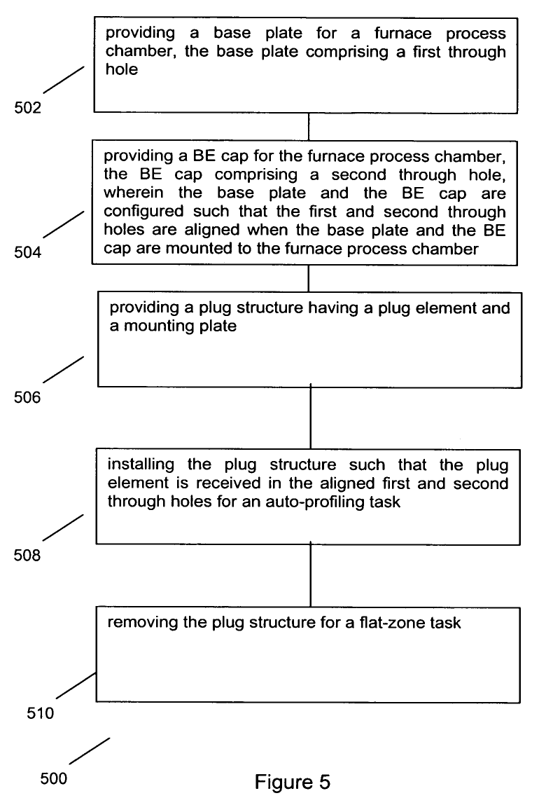

FIG. 5 shows a flowchart 500 illustrating a method of performing a thermocouple calibration in a furnace according to an example embodiment. At step 502, a base plate for a furnace process chamber is provided, the base plate comprising a first through hole. At step 504, a BE cap for the furnace process chamber is provided, the BE cap comprising a second through hole, wherein the base plate and the BE cap are configured such that the first and second through holes are aligned when the base plate and the BE cap are mounted to the furnace process chamber. At step 506, a plug structure having a plug element and a mounting plate is provided. At step 508, the plug structure is installed such that the plug element is received in the aligned first and second through holes for an auto-profiling task. At step 510, the plug structure is removed for a flat-zone task.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An assembly for thermocouple calibration in a furnace, the assembly comprising:
a base plate for a furnace process chamber, the base plate comprising a first through hole;
a Boat Elevator (BE) cap for the furnace process chamber, the BE cap comprising a second through hole, wherein the base plate and the BE cap are configured such that the first and second through holes are aligned when the base plate and the BE cap are mounted to the furnace process chamber; and
a plug structure having a plug element and a mounting plate;
wherein the plug structure is configured such that the plug element is removably received in the aligned first and second through holes.

2. The assembly as claimed in claim 1, wherein the base plate is formed from quartz.

3. The assembly as claimed in claim 1, wherein the plug element is formed from quartz.

4. The assembly as claimed in claim 1, wherein the plug structure further comprises an O-ring for disposal between the mounting plate and the BE cap and around the second through hole for sealing the furnace process chamber.

5. The assembly as claimed in claim 1, wherein the plug structure further comprises a threaded mounting rod connected to the mounting plate for facilitating movement of the plug structure relative to the first and second through holes.

6. A method of performing thermocouple calibration in a furnace, the method comprising the steps of:
providing a base plate for a furnace process chamber, the base plate comprising a first through hole;
providing a BE cap for the furnace process chamber, the BE cap comprising a second through hole, wherein the base plate and the BE cap are configured such that the first and second through holes are aligned when the base plate and the BE cap are mounted to the furnace process chamber; and
providing a plug structure having a plug element and a mounting plate;
installing the plug structure such that the plug element is received in the aligned first and second through holes for an auto-profiling task; and
removing the plug structure for a flat-zone task.

7. The method as claimed in claim 6, further comprising re-disposing the plug structure such that the plug element is received in the aligned first and second through holes after the flatzone task for a further autoprofiling task.

8. The method as claimed in claim 6, wherein the base plate is formed from quartz.

9. The method as claimed in claim 6, wherein the plug-element is formed from quartz.

10. The method as claimed in claim 6, wherein the method further comprises disposing an O-ring between the mounting plate and the BE cap and around the second through hole for sealing the furnace process chamber for the auto-profiling tasks.

11. A furnace comprising:
a process chamber;
a base plate for the process chamber, the base plate comprising a first through hole;
a BE cap for the process chamber, the BE cap comprising a second through hole, wherein the base plate and the BE cap are configured such that the first and second through holes are aligned when the base plate and the BE cap are mounted to the furnace process chamber; and
a plug structure having a plug element and a mounting plate;
wherein the plug structure is removably mounted to the BE cap such that the plug element is removably received in the aligned first and second through holes.
